(19) United States
(12) Patent Application Publication
(10) Pub. No.: US 2014/0279327 A1
(43) Pub. Date: Sep. 18, 2014

(54) Method And Systems For Illuminating Statistical Uncertainties To Empower Decision Making

(71) Applicant: Andrew Keyes, Athens, GA (US)

(72) Inventor: Andrew Keyes, Athens, GA (US)

(21) Appl. No.: 13/840,054

(22) Filed: Mar. 15, 2013

(51) Int. Cl. G06Q 40/00

(52) U.S. Cl. CPC G06Q 40/00
USPC 705/35

(57) ABSTRACT

An interactive method and system determining the results of life style choices over time. The user inputs one or more lifetime goals. In response, the system provides the user with one or more input selections based on the user's goals. The users' selections are classified as an Income or an Expense. The classified Income and Expense selections are further classified as analytic or probabilistic. The one or more analytic selections have a known or calculable quantity. The probabilistic selections have an unknown quantity that can be calculated over time by applying a distribution curve based on real world data. The probabilistic calculations includes one or more iterations such that a value can determined for each Income or Expense and wherein the Income and Expense values are summarized over the appropriate number of iterations such that a cash-flow result is calculated. The cash-flow results that fall within the distribution curve are counted such that the probability of the user reaching their goals based on their lifestyle choices can be determined and displayed graphically via the user interface.

### FIELD OF THE INVENTION

The present invention relates generally to statistical analysis to simulate real world decision making and, more particularly, to methods and systems for using open source data to derive and explore a range of simulated real world results in response to simulated real world decision making.

### BACKGROUND OF THE INVENTION

Historically, the perception of uncertainty has been seen as an obstacle to making good decisions. For example, in planning one's financial future a multiplicity of variables influences such projections, which can lead to high levels of uncertainty. There are infinite choices an individual could make in terms of their lifestyle and future expenditures (such as the type of home, education, or vehicle), which will impact their financial future. Similarly, there are infinite choices an individual can make concerning their ability to earn income or their career path, which will impact their life-long earning potential. Furthermore, variations in the inflation rate, applicable tax rates, as well as the variations in income and expenditures related to other life style choices can make any future financial projections very difficult. Therefore conventional approaches tend rely on a simplified, broad-based approach. There are a number of real world statistical financial applications available which attempt to eliminate such uncertainty by providing a decision maker with the “correct” or “desired” result.

It is an object of the embodiments disclosed herein to provide a method of illuminating uncertainty by providing a user with relativity detailed assessment of their financial future, and which allows the effect of various alternatives to be considered.

### SUMMARY OF THE INVENTION

The embodiments described below are designed to demonstrate how choices can reduce the amount of uncertainty. The embodiments disclosed herein helps a user to practice decision making by allowing the user explore his decisions in a simulated, virtual world where various iterations of the users' decisions are applied many times. The user's decisions are analyzed in light of real world data and the results of the user's decisions are compiled, analyzed and presented back to the user in a format that easy to assimilate.

In an embodiment, a method for illuminating uncertainties to empower decision-making is disclosed. The method provides a user interface stored in memory and executing on a computing device. The computing device accepts user inputs including information related to user demographic and user goals. The computing device uses these inputs to determine one or more output queries. The kind and type of output query presented to the user is based on the accepted user inputs. The one or more input queries are classified as an Income or an Expense. The one or more input queries are classified as analytic or probabilistic. Analytic input drivers have a known or calculable quantity and are summarized over one or more life phases as selected by user. However, probabilistic inputs have an unknown quantity that can be approximated over time by applying a distribution curve based on real world data and are summarized over one or more life phases as selected by user.

The probabilistic values are calculated when a random number generator is used to generate and apply a random number to an inverse of the distribution curve to determine the probability of falling along a particular point on an X-axis of the curve such that the probability of achieving a particular value on the X-axis can be determined. This is then repeated for one or more sufficient iterations until an intermediate or final distribution curve is filled such that for each iteration, a descriptive statistic can be determined for each probabilistic variable along the X-axis. Using the descriptive statistics to calculate summarized Income, Expense, Savings and Cash-flow values over an appropriate number of iterations; such that a Cash-flow and Savings distribution is created based on the user selections. Determining Cash-flow and Savings results are summarized such that the probability of reaching various goals can be determined and displayed graphically via the user interface to indicate the user's probability of attaining various levels of success.

In a second embodiment, a method and system for illuminating uncertainties to empower decision making in achieving lifetime retirement goals is disclosed. The method and system comprises determining one or more output drivers. The output drivers are typically based on one or more desired and measurable user goals. The output drives are used to select one or more input drivers. Furthermore, the one or more input drivers relate to various lifestyle choices of the user.

Once the user selects the input drivers, the method and system classifies the one or more input drivers as an Income or an Expense. The method and system further classifies the one or more input drivers' selections as analytic or probabilistic, wherein the analytic input drivers have a known or calculable quantity. However, the probabilistic input drivers have an unknown quantity that can be calculated over time by applying a distribution curve based on real world data.

The probabilistic input drivers can be calculated by a randomly selecting a value from one or more distribution curves. The resulting intermediate variables are then used to create one iteration. For each of the iterations, a value can be determined for each Income or Expense that is calculated. Furthermore, the Income values are summarized over the appropriate number of iterations and the Expense values are summarized over the appropriate number of iterations such that a cash-flow result is calculated based on the user selections. The cash-flow results that fall within the predefined categories are noted and counted such that the probability of reaching a user goal can be determined. The cash-flow results are summarized and displayed graphically via the user interface to indicate the probability the plan entered by the user will be a success or failure in reaching their goal.

In a further embodiment, method for storing instructions that, when executed by a provided processor in a computing device enables a user to access an interactive game through a provided communications medium and using a provided user interface. The user interface presents one or more interactive inputs based on a series of user goals and user demographics. The user goals can be based on one or more long-term financial goals, and wherein said long-term financial goals are used to determine one or more interactive selections for the user. In an exemplary embodiment, the one more selections can include: one or more educational and income goals; one or more lifestyle and spending choices; and one or more investment and entrepreneurial choices.

In a further exemplary embodiment, the one or more interactive selections are based on one or more age ranges of the user. The processor executes a series of processes for classifying the one or more interactive selections by the user as an Income or an Expense. The processor further classifies the one or more Income or Expense selections as analytic or probabilistic. The one or more analytic selections have a known or calculable quantity. The probabilistic selections have an unknown quantity that can be calculated over time by applying a distribution curve based on real world data.

In an exemplary embodiment, applying a random number generator to an inverse of the distribution curve for one or more sufficient iterations until a sufficient number of iterations are completed to describe the distribution of the intermediate or output variable calculates the probabilistic selections. This allows the Income, Expense and Cash-flow variables for each iteration to be calculated.

Finally, the cash-flow results that fall within the predefined parts of the distribution curve are counted such that the probability of reaching a user goal can be determined and displayed graphically via the user interface to indicate the user's probability attaining various levels of success.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is a flow diagram of an exemplary embodiment of a method for illuminating statistical uncertainties to empower decision-making;

FIG. 2 is a flow chart of an exemplary embodiment of an algorithm for illuminating statistical uncertainties;

FIG. 3a is an example of a distribution curve in an exemplary embodiment;

FIG. 3b is an example of a cumulative distribution curve used in the original direction with a random number generator in an exemplary embodiment;

FIG. 3c is an example of a cumulative distribution curve used in the inverse direction with a random number generator in an exemplary embodiment;

FIG. 4 is a block diagram of an exemplary embodiment of the game collecting demographical information;

FIG. 5 is a block diagram of an exemplary embodiment of the game collecting goal information;

FIG. 6 is a block diagram of an exemplary embodiment of the game collecting lifestyle information at a later stage in life;

FIG. 7 is a block diagram of an exemplary embodiment of the game collecting lifestyle information at a later stage in life;

FIG. 8 is a block diagram of an exemplary embodiment of the game providing financial results;

FIG. 9 is a block diagram of an exemplary embodiment of the game providing probabilities of a user reaching their goals based on their decision making; and

FIG. 10 is a block diagram of an exemplary embodiment of a computing device.

### DETAILED DESCRIPTION

Before the present methods and systems are disclosed and described in greater detail hereinafter, it is to be understood that the methods and systems are not limited to specific methods, specific components, or particular implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. Similarly, “optional” or “optionally” means that the subsequently described event or circumstance may or may not occur, and the description includes instances where the event or circumstance occurs and instances where it does not.

Throughout the description and claims of this specification, the word “comprise” and variations of the word, such as “comprising” and “comprises,” mean “including but not limited to,” and are not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed herein are components that can be used to perform the disclosed methods and systems. It is understood that when combinations, subsets, interactions, groups, etc. of these components are disclosed that although specific reference to each various individual and collective combinations and permutations cannot be explicitly disclosed, each is specifically contemplated and incorporated herein, for all methods and systems. This applies to all aspects of this specification including, but not limited to, steps in disclosed methods. Thus, if there are a variety of additional steps that can be performed it is understood that each of the additional steps can be performed with any specific embodiment or combination of embodiments of the disclosed methods.

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices. An exemplary computer system is detailed in the discussion of FIG. 10 below.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The embodiments disclosed herein provide a system and method for aiding a user in practicing decision making by allowing the user to explore a number of scenarios in a simulated, virtual world environment. The system and method provides an algorithm wherein various iterations of a multitude of user decisions can be analyzed to determine the probability of success or failure based calculations using real-world analytics and data. Embodiments disclosed herein provide a system and method for receiving one or more interactive inputs based on a series of user goals, characteristics and demographics. These interactive inputs are correlated with real-world analytics and data to determine the probability of falling within a distribution function. Both the user inputs and algorithm outputs can be presented to the user in the context of a game, interactive computer application, mobile smartphone application, integrated web browser plugin and the like.

In an exemplary embodiment, the simulation and algorithm are presented to a user in the context of an interactive video game. FIG. 1 is a flow diagram that illustrates the various aspects of an exemplary embodiment in which the present methods and systems can operate. For example, once the application is activated at step 105; a user is presented with a series of interactive options or inputs to determine a user's demographic makeup and to simulate the user's decisions based upon the user's long or short-term goals at step 110. The method then proceeds to step 115. While this embodiment is described using a user's demographics and goals, the inputs could actually involve any query, which illuminates a user's history, experience, wishes and goals.

In an exemplary embodiment, at step 115 the method and system presents the users with a series of income, earning, education and revenue generating choices. Again, although the exemplary embodiment requests income information; this requested information could vary based on how the application is used. In this embodiment, the income choices may include information about the user's chosen profession or trade. Furthermore, the income choice may also include information about a users educational attainment and/or entrepreneurial accomplishments. Once the income information is set, the method can move on to step 120.

Further in the exemplary embodiment, at step 120, the method and system presents the user with one or more lifestyle goals. These lifestyle goals may include spending and investments choices. Typically, these goals may include choices such as the type of home, vehicle or vacations a user takes. Alternatively, the goals may also include investments in savings, investments, and businesses. However, as mentioned previously, the inputs are exemplary, and other immediate choices may be presented to user at this stage in the application. Once these choices are made, the method can proceed to step 125.

At step 125, the user is presented with a series of expense expectations. These expense expectations may include mortgage debt, automobile bill expenses, entrepreneurial ventures, education expenditures, business expenses, and the like. Again the expenses are exemplary and may vary based on how the application is applied. Once all of these inputs have been entered, the method can proceed to step 130.

Next at step 130, the various income goals and lifestyle queries presented in steps 115-125 are repeated for additional stages in a user's life, such as young adult, middle age, and retirement age. These additional input selections for a user at various stages in their life allow the user to more closely identify their lifestyle goals at various milestone points in their life. These inputs allow income and expense calculations for each stage of life. However, in an alternative embodiment, these calculations may be used account for multiple adjustments to a plan or goal over a number of years or cycles. Once these calculations are made, the method moves on to step 135.

Further at step 135, the method and system uses all of the users inputs to calculate “Lifetime” cash-flow for a given age range. These calculations may involve considering real-world income data for the user's level of education and chosen profession. The various levels of income are summarized over a specific time period for each of the various age ranges. However, other analytics may be calculated at this stage based on the various inputs presented to the user. In this embodiment, a lifetime cash-flow is a summation of the income over the various age ranges or stages discussed in step 130 above. Once this lifetime cash-flow is calculated, the method moves on to step 140.

At step 140, the method determines the resulting nest egg at retirement. This lifetime Cash-flow calculation may comprise a simple lifetime cash-flow or lifetime income minus lifetime expense calculations over various phases of a lifetime as will be explained in the discussion of the algorithm below. In addition to Cash-flow, components of the player's selections are used to determine the generation of their retirement nest egg. The nest egg results and presented to the user in step 145.

At Step 145, the process described in steps 125 thru 140 are repeated to created new dataset and distributions of results for multiple “lifetimes,” as the user makes changes and adjustments to their lifestyle goals. The processes triggered by step 145 can be repeated as long as the user chooses. This allows the user to simulate how various life style choices may impact their financial goals. Once a user satisfied with their input and results, the method can proceed to step 150.

At step 150, the resulting datasets and distributions are segmented at predefined ranges such that various levels of success can be describe based on a user's probability of success of falling within a certain range. Again, any variety of analytics may be calculated and presented in this matter. However, in the exemplary embodiment, the lifetime Cash-flow and the retirement nest egg in particular are calculated and presented to the user. This information can be presented graphically in step 155. Once the results are presented in step 155, the application concludes for a single run from choice entry to graphically displaying the results. The user can then return to the data entry level to experiment with the results by altering the one or more choices to determine their impact on the user's goals.

Turning to FIG. 2, in an exemplary embodiment, an algorithm performs calculations to simulate decision making in the context of a game. In alternative embodiments, the algorithms may be use used to simulate decision-making in other contexts, such as financial planning and tax planning applications. The method steps of the algorithm begin at step 210 when a user of the application activates the game. The algorithm must first gather some basic information about the user in order to determine what information is needed from the user. For example, the application will begin by gathering some basic demographical information about the user as illustrated in step 220. This basic demographical information allows the algorithm to determine one or more input drivers as may be necessary to determine what specific data in need to simulate a user's probability of achieving their financial goals. For example, the demographical information may include current age, retirement age, number of children, marital status, etc. Based on the user response to this demographical information, the application may respond to the user with further, more tailored inquiries. These inquires may include lifestyle choices of the user including the level of education of the user, the number of additional income streams the user may attempt, the type of housing a user may select, the type of vehicle a user may purchase, whether the user purchases items with cash or credit, user savings goals, etc. Once this information is gathered, the algorithm can move on to step 230.

At step 230, the algorithm will prompt the user to enter one or more of the user goals. In an exemplary embodiment, these goals may include desired retirement age, desired retirement income, and the like. In the exemplary embodiment, the demographical selections the user selected at step 220 above can be used at this stage to present a series of questions to the user related to the user's long and short term financial goals. The user responds to these questions by inputting certain information or selections. The algorithm analyzes and classifies the inputs as either an income or an expense. The algorithm further classifies the input selections as either analytic or probabilistic. Analytic selections have a known or calculable quantity. Probabilistic selections have an unknown quantity that can be calculated over time by applying a distribution curve based on real world data. Once the user indicates their goals, the method then moves on to step 240.

Further in the exemplary embodiment, at step 240, the user provides various inputs related to their lifestyle choices, such as the type of home they would like to live in or the type of car they would like to drive at various stages of their life. Their lifestyle choices may also include the level of education they wish to attain, their career choices, or entrepreneurial endeavors. Similarly, their life style choices may also include inputs related to their savings, investment, entrepreneurial and other financial strategies. An algorithm calculates the probability of the user reaching each of their financial savings, spending and earnings goals based on the data entered at each of these inquiries. Once this information is entered, the algorithm can begin the crux of analyzing this data at step 250. Once the real-world data has been applied to the probabilistic selections, the method will move on step 250.

In an exemplary embodiment, at step 250, the algorithm begins its mathematical analysis by analyzing the various user inputs from steps 220-250. At step 250, the algorithm gathers and applies real-world data to the probabilistic user inputs. For example, if the user enters education goals and their profession as having a master's degree in elementary education, the algorithm will gather real-world data regarding incomes of elementary school educators who have a master's degree. This real-world data maybe gathered from a variety of sources such as census or other governmental data. The algorithm will record the analytic inputs and will apply a distribution curve based on the real-world data to the probabilistic input selections as illustrated in FIG. 3.

The probabilistic calculations are based on the following probabilistic statistics. The original beta distribution is developed by using real world data to define an approximate shape and location of the frequency distribution FIG. 3a. In turn that would normally be used to determine the probability of receiving a value equal to or less than a point of interest. This probability is defined by the cumulative distribution found in FIG. 3b whereby the initial point of interest is known. The corresponding probability is read by starting at that point of interest, reading up to the intersection with the curve and then reading across to the probability. In this application is inversing the direction of FIG. 3b to arrive at FIG. 3c. FIG. 3c is explaining where we are starting at randomly generated probability, reading across to the curve and then down to the corresponding point of interest.

Turning now to FIG. 3c, in the exemplary embodiment, a distribution curve based on real-world data is selected based on the input selections chosen by the user. For example, the distribution curve in FIG. 3a represented by the original beta distribution of the curve (0. Beta) can illustrate the probability of income and earning potential of, for example, a high school dropout. The Y-axis indicates the frequency of occurrence, while the X-axis can represent income earned. In an exemplary embodiment, income data is obtained from government census data. In this example, the median income of a high school dropout is about $18,000 per year as indicated by the inflection point Z. In this instance, the wages of high school dropouts fall to the left and right of the inflection point Z, such that there is a 50% probability of falling above or below this income level. The algorithm analytically adjusts for the relevant experience level. For example, the probability of falling below this level is greatly increased for new high school dropouts entering the workforce. Therefore, the analysis described below, “recreates” the distribution curve by determining the probability of the user landing at some point on or within the curve based on the user's age, experience level and other factors gathered from the user's input selections. Furthermore, these calculations are made various stages of a user's life, including “young adult (21-30),” “middle age (30-50),” and “pre-retirement (50-54).” Therefore, a number of trial runs or “iterations” are calculated for each stage in the user's life.

Further in FIG. 3c, to simulate the probability of a user falling somewhere within the distribution at various stages of their life, a curve based on the user's years of education and experience and a random number generator is employed with an inverse distribution. As shown in FIG. 3c the illustration provides a Y-axis having a value from negative infinity to positive infinity. In this illustration, the X-axis to the left of the Y-axis has a value from 0 to positive infinity. The area under the curve in O.Beta from X=0 to X=infinity represents the probability of a user earning a particular income within the distribution.

However, given that the user selects their level of education and inputs their income and earning goals, it is possible to determine the user's chances of earning a particular income based on their inputs. Again, although income is being used to describe the curves in FIG. 3 these methods could apply to any kind of probabilistic input. In an exemplary embodiment, the algorithm uses a random number generator to choose a number between 0 and 1. The chosen random number is applied to an inverse of the distribution curve for each of the probabilistic inputs selected by the user. In this example, the probability of falling on or below the curve is preselected and an income value is “determined” based on that probability. Therefore, the random number is applied to the probability in order to determine the financial value of that probability. Further in this example, if the random number generator chose a value of 0.50 (50%) the value along the distribution curve would be an income of $18,000 or the inflection point discussed above. The beta distribution can be “weighted” based on the education level or years of experience of the user for their various stages of life, such as young adult, middle age, pre-retirement, etc.

Further in FIG. 3c, in the illustrated example, a random number 0.32 is applied which indicates an income of approximately $16,000. The application of various random numbers is repeated for at least three hundred (300) iterations to create a true probability spread based on the user's inputs. Thus for each life stage, test runs or “iterations” are ran at least 300 times to determine the user's likelihood of falling within the distribution and the values generated when the user falls within the distribution. Thus, in this example, over 300 different income values are generated. The probability of a user earning a particular income level at a particular stage in the user's life is calculated. Similar calculations are made for each probabilistic input, whether the input is an income or expense. In the exemplary embodiment, the income and expense calculations are resolved for each income and expense over a particular stage in life. Therefore over, 300 iterations are calculated for each stage of life for each probabilistic input. For example, the incomes and expenses may be calculated for stages in life including, young adults, midlife and pre-retirement. However, there may be a multitude of phases for which the quantities could be calculated. However, in the exemplary embodiment, the income and expense values are summarized over the number of years represented by each of these phases.

In the exemplary embodiment, income and expense calculations are generated for each of the three life phases chosen in the exemplary embodiment. However, based on the application of the algorithm, this information could be calculated for any number of phases, wherein each phase could represent any amount of time or any measureable value. Furthermore, probabilistic values will be determined and summarized over the years for each income and expense input by the user. In the exemplary embodiment, these calculations are generated for the young adult phase (21-30), midlife phase (30-50) and pre-retirement (50-54). Similarly, the analytic results for each of the three phases are also summarized. Therefore, Income=Income (probabilistic)×Income (analytic). Similarly Expense=Expense (probabilistic)×Expense (analytic). Calculations are generated for each of these values for the three phases described above. Thus, I₁ [Income (phase 1)]=[Starting Income (phase 1){probabilistically determined based on education and additional income}×Coefficient (phase 1){analytically determined based on number of years in phase}]. Likewise, E₁ [Expense (phase 1)]=[Housing Expense(phase 1)×Housing Coefficient (phase 1)+Transportation Expense (phase 1)×Transportation Coefficient (phase 1)+Nest Egg Contribution (phase 1)]. In the exemplary embodiment, these calculations will also be made for phase 2 (I₂ & E₂) and phase 3 (I₃ & E₃). These calculations are then repeated over multiple lifetimes to build a sufficient dataset. Once these values have been determined for each of the analytic and probabilistic inputs, the method will move on step 260.

In an exemplary embodiment, at step 260, the algorithm the use the analytic and probabilistic results to calculate cash-flows during each of the three phases mentioned above. The formula for the cash-flow equation is a simply Cash-flow=Income−Expenses. Therefore, in the exemplary embodiment, three cash-flows are calculated in order to determine the lifetime Cash-flow. For example, CF₁=I₁−E₁; CF₂=I₂−E₂ and CF₃=I₃−E₃, wherein CF=Cash-flow, I=income and E=expense. The lifetime Cash-flow is the sum of these three values.

The lifetime Cash-flow calculations demonstrate to the user how education attained and/or the number and size of successful entrepreneurial ventures will influence the user's income goals over the course of the user's life. The cash-flow calculations further illustrate to the user how their lifestyle decisions such as the type of expenses they may incur in buying a house, car or contributing to savings and investments might impact their long-term goals.

In the exemplary embodiment, the cash-flow calculation will provide the user with feedback regarding whether their choices will place them on a path to bankruptcy, independency and insecurity, independency and security, independent and influential, or independent and impactful. The bankruptcy results when a user's income is less than their expenses. The goal is to avoid more than a twenty percent (20%) chance of falling into this category. The independent and insecure results when the use has enough money to pay his or expenses, but not enough cover unexpected downfalls like serious illness or lawsuits. When the lifetime cash-flow of a user is high enough for the user to be comfortable, such as when they can easily afford healthcare costs and make risky investments, the user is classified as Independent and Secure. However, the main goal of the simulation is to become independent and influential. At the independent and influential level, the user's choices has resulted in a lifestyle that allows them to have enough money to live the lifestyle they desire, while also having enough money left over for charitable donations, political donations, venture capital investments, and the like. A step beyond this level is independent and impactful. Users in the independent and impactful level are generally wealthy and have the ability to make a large impact on society by generating influence on a regional or global scale. The algorithm is used to calculate a user's probability of falling into one of these categories based on their lifestyle choices.

Further in the exemplary embodiment, the algorithm calculates the project retirement “nest egg” or savings based on the user's input selections. These calculations are based on a users input selections related to their level or retirement contributions and retirement savings goals over the three life phases mentioned above. Therefore, the earlier a user contributes to their retirement savings, the more likely they are to have a substantial nest egg upon retirement. Since these calculations are both probabilistic from real world data and analytical, their impact on the cash-flow component presents a more transparent view of probable outcomes versus historically available of projections with an unreasonable number of caveats, assumptions and exemptions. It is this transparency into the probability of attaining various levels of success that enable the player to build the plan that can have the greatest probability of attaining his goals.

In the exemplary embodiment, the nest egg calculations may fall into one of at least five categories. For example, a user who makes poor choices may face retirement with little or no savings. This result will be classified as Risky, because the user will not have enough money to have a successful financial future and may become dependent upon others to finance their lifestyle. However, if the user makes better choices and is able to save a decent amount of money their results will be classified as Good, which indicates that there should be enough money for the user to maintain a conservative lifestyle. However, better decisions and more money will lead to better choices and users who make better decisions may fall into the classification of Very Good. This classification means the user has a large enough nest egg to allow them have more financial freedom of and provide minimal assistance to others. However, the goal is for users to fall into the category of Great. This level of savings means a user has a significant nest egg and is financially secure for the rest of their lives. The user has enough in savings to have the lifestyle they choose while also having the ability to help others. Finally, users who are able to make the kind of decisions that result in them becoming very wealthy by retirement age may be classified as Outstanding. The outstanding category identifies users who have arrived at a level of luxury by retirement. Their future is secure and they have the ability to impact society.

In the exemplary embodiment, at step 270, the results are presented to the user in graphical format as indicated FIG. 8. The algorithm calculates the probability that the user will fall into either of the five cash-flow categories and/or the five nest egg categories. This feedback with allow the user to experiment with how their life style choices, educational goals and spending decisions will impact their long term planning.

Turning now to FIGS. 4-9 we able to view how the choices and results are presented to a user in the context of a game. For example, in FIG. 4 the game gathers demographical information about the user. The options presented in this image are examples and a number of different demographic related questions can be presented here. FIG. 5 illustrates the types of questions that may be generated for a user as a result of the demographical information collected in FIG. 4. In this example, these questions are generated for a young adult user (ages 21-30), however the questions could also be presented for users who are further along in life. In fact, the questions may vary depending on the phase or stage of life the user falls into. FIGS. 5-7 illustrate how the responses to a question may vary based on the age or phase of life of the user. Additional information may be provided to user in their financial planning decisions. For example, in FIG. 8, information is presented to the user to illustrate how their income and savings decisions impact their cash-flow. In this example, the user has the ability to analyze how their savings have generated a significant amount of income over the years. Finally, FIG. 9 illustrates to the user the five possible categories their lifetime decisions may play in their lives. There is no “right” answer in this game, only possible “results” from a user decisions. Although the discussion is presented here in terms of retirement planning, the algorithm could be applied to number of applications having analytic and probabilistic inputs.

Turning now to FIG. 10, one skilled in the art will appreciate that the systems and methods disclosed herein can be implemented via a general-purpose computing device in the form of a computer 1001. The components of the computer 1001 can comprise, but are not limited to, one or more processors or processing units 1003, a system memory 1012, and a system bus 1013 that couples various system components including the processor 1003 to the system memory 1012. In the case of multiple processing units 1003, the system can utilize parallel computing.

The system bus 1013 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Private Branch Exchange (PBX) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and each of the subsystems, including the processor 1003, a mass storage device 1004, an operating system 1005, software 1006, data 1007, a network adapter 1008, system memory 1012, an input/output interface 1010, a display adapter 1009, a display device 1011, a human machine interface 1002, can be contained within one or more remote computing devices 1014a,b,c at physically separate locations, connected through buses of this form, in effect implementing a fully distributed system.

The computer 1001 typically comprises a variety of computer readable media. Exemplary readable media can be any available media that is accessible by the computer 1001 and comprises, for example and not meant to be limiting, both volatile and non-volatile media, as well as, removable and non-removable media. The system memory 1012 comprises computer readable media in the form of volatile memory, such as random access memory (RAM), and/or non-volatile memory, such as read only memory (ROM). They system memory 1012 may contain data such as media, video, audio, or other data 1007 and/or program modules such as operating system 1005 and software 1006 capable of manipulating, translating, transcoding, or otherwise editing the data 1007 that are immediately accessible to and/or presently operated on the by the processing unit 1003.

In another aspect, the computer 1001 can also comprise other removable/non-removable, volatile/non-volatile computer storage media. By way of example, FIG. 10 illustrates a mass storage device 1004, which can provide non-volatile storage of computer code, computer readable instructions, data structures, program modules and other data for the computer 1001. For example, a mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, including by way of example, an operating system 1005 and the illumination application software 1006. Each of the operating system 1004 and illumination application software 1006 (or some combination thereof) can comprise elements of the programming and the illumination application software 1006. Media, video, audio, or other data 1007 can be stored in any of one or more databases known in the art.

In another aspect, the user can enter commands and information into the computer 1001 via client device or an input device (not shown). Example of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 1003 via a human machine interface 1002 that is coupled to the system bus 1013, but can be connected by other interface and bus structures, such as a parallel port, game port, and IEEE 1394 Port (also known as a Firewire port), a serial port, or a universal serial bus (USB).

In yet another aspect, a display device 1011 can also be connected to the system bus 1013 via an interface, such as a display adapter 1009. It is contemplated that the computer 1001 can have more than one display adapter 1009, and the computer 1001 can have more than one display device 1011. For example, a display device can be a monitor, an LCD (Liquid Crystal Display), or a projector. In addition to the display device 1011, other output peripheral devices can comprise components such as speakers (not shown) and a printer (not shown), which can be connected to the computer 1001 via input/output interface 1010. Any step and/or result of the methods can be output in any form to an output device. Such output can be any form of visual representation, including but not limited to, textual, graphical, animation, audio, tactile, and the like. The display 1011 and computer 1001 can be part of one device, or separate devices.

The computer 1001 can operate in a networked environment using logical connections to one or more remote computing devices 1014a,b,c. By way of example, a remote computing device can be a personal computer, portable computer, smartphone, softphone, client device, a server, a router, a network computer, a peer device or other common network node, and so on. Logical connections between the computer 1001 and remote computing device 1014a,b,c can be made via a network 1015, such as a local area network (LAN) and or a general wide area network (WAN). Such network connections can be through a network adapter 1008. A network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components reside at various times in different storage components of the computing device 1001, and are executed by the data processor(s) of the computer. An implementation of media manipulation software 1006 can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent system (e.g. Expert interference rules generated through a neural network or production rules from statistical learning).

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, mobile phones, softphones, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for illuminating uncertainties to empower decision-making comprising:
providing a user interface stored in memory and executing on a computing device capable of accepting user inputs and providing outputs, wherein the computing device provides for,
accepting user inputs including information related to user demographic and user goals,
determining one or more output queries for selection by the user wherein the kind and type of output query presented to the user is based on the accepted user inputs, wherein the user response to the output queries are used for:
classifying the one or more user inputs as an Income or an Expense,
further classifying the one or more user inputs as analytic or probabilistic, wherein;
analytic inputs have a known or calculable quantity and are summarized over one or more life phases as selected by user, and
probabilistic inputs have an unknown quantity that can be approximated over time by applying a distribution curve based on real world data and is summarized over one or more life phases as selected by user, wherein
a random number generator is used to generate a random number that the computing device can apply to an inverse of the distribution curve to determine the probability of falling along a particular point on an X-axis of the curve such that the probability of achieving a particular value on the X-axis can be determined;
repeating for one or more sufficient iterations until an intermediate or final distribution curve is filled such that for each iteration, a descriptive statistic can be determined for each probabilistic variable along the X-axis;
using the descriptive statistics to calculate summarized Income, Expense, Savings and Cash-flow values over an appropriate number of iterations; such that a Cash-flow and Savings distribution is created based on the user selections, and wherein
determining Cash-flow and Savings results are summarized such that the probability of reaching various goals can be determined and displayed graphically via the user interface to indicate the user's probability of attaining various levels of success.

2. The method according to claim 1, wherein an output driver may include demographic factors, such as secure retirement age, desired location, level of retirement income, Cash-flow over a lifetime, lifetime taxes, size of the retirement nest egg, etc.

3. The method according to claim 1, wherein an input query may include desired lifestyle choices such as type of home, type of car, level of education, career and income choices, investment strategies, entrepreneurial goals, number of children, starting age, targeted retirement age, etc.

4. The system according to claim 1, wherein the distribution curve is based on real world data.

5. The method according to claim 1, wherein the determining of the probability of reaching the defined goals can be calculated at one or more different life phases.

6. The method according to claim 1, wherein the shape of the distribution curve is influenced by one or more risk management factors such as, Insurance, Emergency Cash Fund, National or Regional unemployment rate, etc.

7. The method according to claim 1, wherein the user goal is a retirement savings at a specific age of the user.

8. The method according to claim 1, wherein the Cash-flow for one lifetime can be calculated based on an equation Cash-flow=Σ(Iₓ−Eₓ)ₙ, SUM for N number of life phases, wherein I is income for a predetermined period, E is expenses for a predetermined period.

9. The method according to claim 1, wherein the Cash-flow for multiple life phases can be gathered to build a dataset to which descriptive statistics can be applied.

10. The method according to claim 1, wherein only input drivers that meet a predetermined threshold are considered.

11. A system for executing on a computing device for illuminating uncertainties to empower decision-making wherein the system comprises code stored in a memory of the computing device and operable through a user interface comprising:
an input device operable via the user interface for selecting one or more output drivers, wherein the output drivers are based on one or more measurable user goals and user demographics;
selecting one or more input queries via the user interface, wherein the input queries are based upon the determined output drivers and wherein said one or more input queries relate to lifestyle choices of the user, and wherein
the computing device classifying one or more input query selections as an Income or an Expense,
the computing device further classifying the one or more input query selections as analytic or probabilistic, wherein;
analytic input selections have a known or calculable quantity and are summarized for one or more life phases as selected by user, and
probabilistic input selections have an unknown quantity that can be approximated over time and are summarized for one or more life phases as selected by user, by randomly selecting from a distribution curve based on real world data, wherein
a random number generator is used to generate a random number that the computing device can apply to an inverse of the distribution curve to determine the probability of falling a particular point along an X-axis of the curve such that the probability of achieving a particular value on the X-axis can be determined;
repeating for one or more sufficient iterations until an intermediate or final distribution curve is filled such that for each iteration, a descriptive statistic can be determined for each probabilistic variable along the X-axis; and
using the descriptive statistics to calculate summarized Income, Expense, Savings and Cash-flow values over an appropriate number of iterations; such that a Cash-flow and Savings distribution is created based on the user selections, and wherein
determining Cash-flow and Saving results such that the probability of reaching various goals can be determined and displayed graphically via the user interface to indicate the user's probability of attaining various levels of success.

12. The system according to claim 11, where the determined probability of reaching a user goal is displayed graphically to the user as illustrated in a pie chart or other graphical representation.

13. The system according to claim 11, wherein the Cash-flow for multiple life phases can be gathered to build a dataset to which descriptive statistics can be applied.

14. A method for storing instructions that, when executed by a provided processor in a computing device enables a user to access an interactive game through a provided communications medium and using a provided user interface, the interactive game comprising:
one or more interactive inputs based on a series of user goals and user demographics, wherein said user goals are:
based on one or more financial goals, and wherein said financial goals are used to determine one or more interactive selections for the user, wherein the one more selections can include:
one or more educational and income goals,
one or more lifestyle and spending choices, and
one or more investment and entrepreneurial choices, and wherein the one or more interactive selections are based on one or more age ranges of the user;
said processor executing a series of processes for classifying the one or more interactive selections for the user as an Income or an Expense,
further classifying the one or more Income or Expense selections as analytic or probabilistic, wherein;
analytic input selections have a known or calculable quantity and are summarized for one or more life phases as selected by user, and
probabilistic input selections have an unknown quantity that can be approximated over time and are summarized for one or more life phases as selected by user, by randomly selecting from a distribution curve based on real world data, wherein
a random number generator is used to generate a random number that the computing device can apply to an inverse of the distribution curve to determine the probability of falling a particular point along an X-axis of the curve such that the probability of achieving a particular value on the X-axis can be determined;
repeating for one or more sufficient iterations until an intermediate or final distribution curve is filled such that for each iteration, a descriptive statistic can be determined for each probabilistic variable along the X-axis; and
using the descriptive statistics to calculate summarized Income, Expense, Savings and Cash-flow values over an appropriate number of iterations; such that a Cash-flow and Savings distribution is created based on the user selections, and wherein
determining Cash-flow and Saving results such that the probability of reaching various goals can be determined and displayed graphically via the user interface to indicate the user's probability of attaining various levels of success.

15. The method according to claim 14, wherein the Cash-flow for multiple lifetimes can be gathered to build a dataset to which descriptive statistics can be applied.

16. The method according to claim 14, wherein an investment or entrepreneurial choice includes developing passive income.

17. The method according to claim 14, wherein a financial goal includes avoiding interest based liabilities and debt unless it will fuel growth greater than the interest.

18. The method according to claim 14, wherein a financial goal includes developing multiple streams of income.

19. The method according to claim 14, wherein the one or more interactive inputs include a series of visual indicators.

20. The method according to claim 14, wherein the series of visual indicators can include actual graphical images of real lifestyle choices including type of home, type of car, and other expenses selectable by the user.
